(19) United States
(12) Patent Application Publication
(10) Pub. No.: US 2005/0209382 A1
(43) Pub. Date: Sep. 22, 2005

(54) Liquid dispersion polymer thickeners for aqueous systems

(76) Inventors: David Yale, White Plains, NY (US); Frances A. Amy, White Plains, NY (US); Howard Dungworth, Huddersfield (GB); Michael Green, Huddersfield (GB)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/080,334

(22) Filed: Mar. 15, 2005

Related U.S. Application Data
(60) Provisional application No. 60/553,755, filed on Mar. 17, 2004.

(51) Int. Cl. C08K 5/06

(52) U.S. Cl. 524/379; 524/556

(57) ABSTRACT

Disclosed is an aqueous latex emulsion coating composition comprising a liquid dispersion polymer, said liquid dispersion polymer comprising a hydrophilic nonionic or anionic homopolymer or copolymer dispersed in a hydrophobic liquid carrier and containing an oil-in-water activator surfactant and wherein the liquid dispersion polymer is in the form of microparticles. The hydrophilic homopolymers or copolymers comprise for example monomer units derived from acrylic acid or acrylic acid salts. Also disclosed is an associative liquid dispersion polymer, said liquid dispersion polymer comprising a hydrophilic nonionic or anionic copolymer dispersed in a hydrophobic liquid carrier and containing an oil-in-water activator surfactant and wherein the liquid dispersion polymer is in the form of microparticles, and wherein the copolymer contains a minor amount of associative monomer units derived from ethylenically unsaturated monomers selected from the group consisting of the associative monomers. The associative liquid dispersion polymers are useful as thickeners for aqueous emulsion systems.

This application claims benefit under 35 USC 119(e) of U.S. provisional application No. 60/553,755, filed Mar. 17, 2004.

Disclosed are liquid dispersion polymers as thickeners for latex paints. Also disclosed are associative liquid dispersion polymers and their use as thickeners for aqueous latex emulsion systems.

U.S Pat. No. 4,395,524 teaches nonionic and anionic copolymers of acrylamide and N-substituted acrylamides as flow modifiers for aqueous systems.

U.S. Pat. No. 6,365,656 discloses liquid dispersion polymers that are acrylic-based polymers dispersed in a di- or triglyceride oil and an oil-in-water surfactant.

U.S. Pat. No. 4,075,141 discloses coatings compositions prepared by adding insoluble crosslinked polymeric microparticles to solutions or dispersions of carboxylic acid amide interpolymers.

Viscalex® AT88, Ciba Specialty Chemicals, Data Sheet of January, 2000, is described as an acrylic copolymer carried in an aliphatic hydrocarbon and containing a small amount of surfactant which emulsifies the carrier solvent. It is described for use in adhesives and latex, for example from 0.5 to 1.0%.

### SUMMARY

The present invention is aimed at the use of certain liquid dispersion polymers as thickeners for aqueous latex emulsion paints (i.e. coatings formulations or compositions). The present invention is also aimed at new associative liquid dispersion polymers and their use as thickeners in aqueous emulsion systems, for example paints, adhesives, inks, pigment dispersions, latex and the like. The present thickeners may completely replace cellulosic thickeners in such systems.

Disclosed is an aqueous latex emulsion coating formulation comprising a liquid dispersion polymer,
said liquid dispersion polymer comprising a hydrophilic nonionic or anionic homopolymer or copolymer dispersed in a hydrophobic liquid carrier and containing an oil-in-water activator surfactant and wherein the liquid dispersion polymer is in the form of microparticles.

Also disclosed is an aqueous latex emulsion coating formlulation comprising said liquid dispersion polymer, wherein essentially no cellulosic thickeners are present. For example, cellulosic thickeners are completely replaced by the present thickeners.

Further disclosed is a new associative liquid dispersion polymer, said polymer comprising a hydrophilic nonionic or anionic copolymer dispersed in a hydrophobic liquid carrier and containing an oil-in-water activator surfactant and wherein the liquid dispersion polymer is in the form of microparticles, and
where the copolymer comprises a minor amount of monomer units derived from at least one monomer selected from the group consisting of the associative monomers.

The associative liquid dispersion polymers are useful as thickeners for aqueous latex emulsion systems. The associative liquid dispersion polymers may also replace essentially all or completely replace cellulosic thickeners in these systems.

The aqueous latex emulsion systems of this invention have improved rheological properties, superior flow and leveling, and good film build. The latex emulsion systems also have excellent long term stability.

### DETAILED DISCLOSURE

The present liquid dispersion polymers comprise a hydrophilic nonionic or anionic homopolymer or copolymer, a hydrophobic liquid as a carrier, and an oil-in-water activator surfactant.

The present associative liquid dispersion polymers comprise the same three components, wherein the nonionic or anionic copolymer further contains monomer units derived from at least one monomer selected from the group consisting of the associative monomers. According to this invention, these copolymers are termed “nonionic or anionic associative copolymers”.

The present associative liquid dispersion polymers comprise a hydrophilic nonionic or anionic copolymer, which copolymer is derived from a major portion of monomers selected from the group consisting of the nonionic and anionic monomers and is derived from a minor portion of monomers selected from the group consisting of the associative monomers.

The term “monomer units derived from” refers to the polymerized monomers when they are part of a polymer or copolymer. Likewise, the term “polymer derived from monomers” means the polymer is made of the reacted (polymerized) monomers.

The nonionic or anionic homopolymers or copolymers of this invention are prepared from ethylenically unsaturated monomers. Nonionic polymers are prepared from (derived from) nonionic monomers and anionic polymers are prepared from anionic monomers or from a mixture of nonionic and anionic monomers.

Suitable anionic monomers include acrylic acid, methacrylic acid and their alkali metal and ammonium salts, 2-acrylamido-2-methyl-propanesulfonic acid and its salts, sodium styrene sulfonate and the like. Acrylic acid is the most preferred anionic monomer. In the present polymers or copolymers, the carboxylic acid groups are at least about 50%, advantageously about 65% to about 85% in the form of an alkali metal salt or ammonium salt, especially the sodium salt or the ammonium salt.

Suitable nonionic monomers include acrylamide, methacrylamide, N-vinyl pyrrolidone and water soluble hydroxy-substituted acrylic or methacrylic esters.

The present copolymers comprise monomer units derived from more than one of the above monomers.

If a blend monomers is used to produce an anionic copolymer, the amount of anionic monomer is preferably more than 60% by weight of the blend, and usually it is at least 80% by weight of the blend. The preferred anionic polymers are formed wholly from anionic monomers.

The associative monomers are known and are ethylenically unsaturated amphiphilic monomers, for example stearyl ethoxy (20) methacrylate, behenyl ethoxy (25) methacrylate, stearyl ethoxy (10) allyl ether, poly(ethylene glycol)(meth)acrylate, poly(ethylene glycol)monomethyl ether mono(meth)acrylate, poly(ethylene glycol)acrylate and poly(ethylene glycol)monomethyl ether monoacrylate. The numbers in parentheses mean the number of repeating ethoxy units.

The associative monomers are present in the copolymers in a minor amount, based on the weight of the copolymer. For example, the associative monomers are present at less than about 5% by weight, based on the weight of the copolymer. For example, the associative monomers are present at less than about 3%, less than about 2%, less than about 1%, or less than about 0.5% by weight, based on the weight of the copolymer. For example, the associative monomers are present in the copolymers from about 0.1% to about 0.5%, based on the weight of the copolymer. The associative monomers are present for example from about 0.1% to about 1%, from about 0.1% to about 2%, from about 0.1% to about 3%, or from about 0.1% to about 5% by weight, based on the weight of the copolymer. For example, the associative monomers are present in the copolymers at about 0.1%, 0.2%, 0.3%, 0.4% or about 0.5% by weight, based on the weight of the copolymer.

The terms “major amount” and “minor amount” refer to a majority or minority of the weight percent. For example, “major amount” means greater than or equal to about 90% by weight and “minor amount” means less than or equal to about 10% by weight.

The hydrophobic liquid is a liquid with sufficiently low miscibility with water so that it can be used as the non aqueous phase in a reverse phase polymerization. The liquid must have substantially no solvating effect for the polymer, or for the monomers from which the polymer is derived, throughout the range of temperatures at which the polymer is likely to be synthesized (for example from about 15 to about 100° C.). Likewise, the nonionic and anionic monomers must be water soluble to enable reverse phase polymerization. The hydrophobic liquid is for example a hydrocarbon oil, for example mineral oil (paraffin oil).

The amount of the hydrophobic liquid phase used in the polymerization is dictated primarily by the need to provide a satisfactory reverse phase emulsion medium. This would generally be at least about 1 part by weight of the hydrophobic liquid per part by weight of the hydrophilic polymer or copolymer (dry weight).

In order to obtain liquid dispersion polymer compositions having higher amounts of the microparticles in the oil, for example from about 1.2 to about 1.7 parts by weight of the hydrophilic polymer or copolymer (dry weight) in the hydrophobic carrier, as well as to facilitate processing, it is expedient to employ a further volatile inert hydrophobic solvent. Suitable inert hydrophobic solvents include hydrocarbons and halogenated hydrocarbons.

Conveniently about 1 to about 2 parts, for example about 1.3 to about 1.9 parts of the volatile inert hydrophobic solvent per part of the hydrophilic polymer on a dry weight basis is employed.

The oil-in-water activator surfactant is for example a nonionic oil-in-water emulsifier having an HLB greater than or equal to about 10, for example greater than or equal to about 12 (high HLB surfactant). Suitable emusifiers are well known. Ethoxylated aliphatic alcohols are preferred, for example mono-ethoxylated or poly-ethoxylated tridecylalcohol. Poly-ethoxylated means for example from about 2 to about 10 repeating ethoxylate units. The activator surfactant may be a mixture of suitable surfactants. The amount of the activator surfactant employed is described below.

The present liquid dispersion polymers and associative liquid dispersion polymers may be obtained in the form of microparticles having an average particle size in the range of about 0.1 to about 2 microns by reverse phase emulsion polymerization of suitable monomers in the hydrophobic liquid.

The polymer or copolymer is prepared by conventional reverse phase emulsion procedures, namely by adding about 1 part by weight (dry weight) of at least one aqueous ethylenically unsaturated monomer, optionally including a sequesterant, into about 1 to 3 parts by weight of a hydrophobic liquid containing about 0.1 to about 0.2 parts of at least one conventional water-in-oil emulsifier having a HLB value less than or equal to about 9 (low HLB surfactant) and optionally about 0.1 to about 0.2 parts of a polymeric stabilizer surfactant, with intensive agitation so as to form a substantially stable emulsion of the required fine particle size. Suitable water-in-oil emulsifiers are well known to those skilled in the art. Sorbitan esters such as sorbitan monooleate and ethoxylated sorbitan esters are preferred, with mixtures thereof being especially preferred. Diethylenetriamine pentaacetic acid, sodium salt is a suitable sequesterant.

The reaction mixture is purged with nitrogen and polymerization is initiated by addition of a conventional source of free radicals. Suitable polymerization initiators are well known to those skilled in the art. Typical free radical-forming catalysts include peroxygen compounds such as sodium, potassium and ammonium persulfates, caprylyl peroxide, benzoyl peroxide, hydrogen peroxide, pelargonyl peroxide, cumene hydroperoxide, tertiary butyl diperphthalate, tertiary butyl perbenzoate, sodium peracetate, di(2-ethylhexyl)peroxydi-carbonate, and the like, as well as azo catalysts such as azodiisobutyronitrile. Other useful catalysts are the heavy metal-activated catalyst systems. A preferred type of polymerization initiator is a redux initiation pair. After initiation appropriate temperature and agitation conditions are maintained until the conversion of the monomer to polymer is substantially complete. Appropriate conditions are well known to those of ordinary skill in the art.

The water and any volatile solvent are then removed from the reverse phase emulsion, for example by distillation under reduced pressure, so as to produce a substantially anhydrous stable dispersion of polymer particles less than about 2 microns in size dispersed in the hydrophobic liquid.

About 0.5% to about 15% by weight, based on the weight of the composition, for example from about 1% to about 12% by weight of the activator surfactant is added after distillation is complete. For example, about 2% to about 8% by weight of the activator surfactant is added after distillation is complete. The ratio of the high HLB surfactant to the low HLB surfactant in the final liquid dispersion polymers and associative liquid dispersion polymers is for example from about 1:4 to about 4:1, from about 1:3 to about 3:1, from about 1:2 to about 2:1, or about 1:1 by weight.

A suitable amphipathic “stabilizer” surfactant (polymeric stabilizer surfactant) may optionally be employed as a processing aid to maintain emulsion integrity through the distillation process and to provide for the final liquid polymer dispersion to be a free flowing liquid, even when it contains high levels of microparticles of the water soluble or swellable dispersed polymer or copolymer. Advantageously about 0.02 to about 0.3 parts, especially about 0.1 to about 0.2 parts of this stabilizer surfactant is employed per part by weight (dry weight) of the ethylenically unsaturated monomer or monomers.

For example, the amphipathic stabilizer surfactant is a polymer which is a reaction product of poly-12-hydroxystearic acid, glycidyl methacrylate and methacrylic acid. For example, a reaction product of 60 to 80% by weight of poly-12-hydroxystearic acid, 10% to 20% of glycidyl methacrylate and 5% to 25% by weight of methacrylic acid.

The polymer of poly-12-hydroxystearic acid, glycidyl methacrylate and methacrylic acid may be prepared as disclosed in U.S. Pat. No. 6,365,656, the disclosure of which is hereby incorporated by reference.

The amphipathic stabilizer may also be a low molecular weight copolymer or cooligomer of a water soluble monomer and a water insoluble hydrophobic monomer. Water soluble monomers are for example acrylic acid and methacrylic acid. Water insoluble monomers are those for example wherein less than about 0.2 parts by weight part of the monomer will dissolve in 100 weight parts water. Exemplary hydrophobic monomers include the higher alkyl esters of alpha,beta-ethylenically unsaturated carboxylic acids such as dodecyl acrylate, dodecyl methacrylate, tridecyl acrylate, tridecyl methacrylate, tetradecyl acrylate, tetradecyl methacrylate, octadecyl acrylate, octadecyl methacrylate, stearyl methacrylate, ethyl half ester of maleic anhydride, diethyl maleate, and other alkyl esters derived from the reactions of alkanols having from 8 to 20 carbon atoms with ethylenically unsaturated carboxylic acids such as acrylic acid, methacrylic acid, maleic anhydride, fumaric acid, itaconic acid and aconitic acid, alkylaryl esters of ethylenically unsaturated carboxylic acids such as nonyl-alpha-phenyl acrylate, nonyl-alpha-phenyl methacrylate, dodecyl-alpha-phenyl acrylate and dodecyl-alpha-phenyl methacrylate; N-alkyl, ethylenically unsaturated amides such as N-octadecyl acrylamide, N-octadecyl methacrylamide, N,N-dioctyl acrylamide and similar derivatives thereof; alpha-olefins such as octene-1, decene-1, dodecene-1 and hexadecene-1; vinyl alkylates wherein alkyl has at least 8 carbons such as vinyl laurate and vinyl stearate; vinyl alkyl ethers such as dodecyl vinyl ether and hexadecyl vinyl ether; N-vinyl amides such as N-vinyl lauramide and N-vinyl stearamide; and ar-alkylstyrenes such as t-butyl styrene. Of the foregoing hydrophobic monomers, the alkyl esters of acrylic acid and methacrylic acid wherein alkyl has from 8 to 20 carbon atoms, are preferred. The alkyl methacrylates wherein alkyl has from 10 to 20 carbon atoms are more preferred.

The liquid dispersion polymer compositions may be advantageously crosslinked by incorporating a small amount of a suitable crosslinking agent such as a polyfunctional vinyl addition monomer into the polymerization mixture. Preferably a water soluble crosslinking agent is used.

Any of the conventional polyethylenically unsaturated cross linking agents which are soluble in the monomer or monomer blend can be used, including materials which are di-, tri- or tetraethylenically unsaturated. Preferred are diethylenically unsaturated compounds such as methylene bis acrylamide, ethylene glycol di(meth) acrylate, di (meth)acrylamide, vinyloxyethylacrylate or -methacrylate and the like. Methylene bis acrylamide is the most preferred crosslinking agent.

The amount of cross linking agent is generally in the range from about 100 to about 10,000 parts by weight of cross linking agent per million parts (by dry weight) of the monomer or monomers. Most preferably it is around 500 to about 2000 ppm, especially about 500 to about 900 ppm. Optimum amounts can be determined by routine experimentation.

The present liquid dispersion polymers then comprise
a hydrophilic nonionic or anionic homopolymer or copolymer, i.e., a water soluble or swellable dispersed polymer or copolymer,
a hydrophobic liquid carrier,
a mixture of a low HLB surfactant and a high HLB surfactant (water-in-oil surfactant and oil-in-water surfactant), and
other minor and optional components including for example residual water, residual volatile hydrocarbon solvent, and polymeric stabilizer.

For example, the present liquid dispersion polymers comprise from about 35% to about 65% by weight of a hydrophilic nonionic or anionic homopolymer or copolymer,
from about 10% to about 50% by weight of a hydrophobic liquid carrier, and from about 5% to about 25% by weight of the surfactant mixture, each based on the weight of the total composition.

For instance, the liquid dispersion polymers comprise
from about 40% to about 60% by weight of the nonionic or anionic homopolymer or copolymer,
from about 15% to about 45% by weight of a hydrophobic liquid carrier, and
from about 8% to about 20% by weight of the surfactant mixture, each based on the weight of the total composition.

In particular, the liquid dispersion polymers comprise
from about 45% to about 58% by weight of the nonionic or anionic homopolymer or copolymer,
from about 20% to about 40% by weight of a hydrophobic liquid carrier, and
from about about 10% to about 18% of the surfactant mixture, each based on the weight of the total composition.

For instance, the present liquid dispersion polymers comprise
from about 45% to about 58% by weight of the nonionic or anionic homopolymer or copolymer,
from about 20% to about 40% by weight of a hydrophobic liqud carrier, and
from about 10% to about 18% of the surfactant mixture, each based on the weight of the total composition.

For instance, the present liquid dispersion polymers comprise
from about 45% to about 58% by weight of an anionic copolymer comprising monomer units derived from acrylic acid and an alkali metal or ammonium salt of acrylic acid, and
from about 22% to about 38% by weight of a hydrophobic liquid carrier, and
from about 12% to about 18% by weight of the mixture of surfactants, each based on the total weight of the composition.

For example, greater than about 50%, or from about 65% to about 85% of the acid groups in an anionic acrylic acid copolymer are in the form of a salt, for example the sodium or ammonium salt.

The present associative liquid dispersion polymers have the same weight ratios as above, wherein the nonionic or anionic associative copolymer replaces the nonionic or anionic homopolymer or copolymer.

The present liquid dispersion polymers and associative liquid dispersion polymers are employed as thickeners in latex emulsion systems at levels from about 0.1% to about 8% by weight, based on the weight of the entire composition. For example, the present dispersion polymers are employed at levels from about 0.5% to about 7%, from about 1% to about 6% or from about 2% to about 5% by weight, based on the weight of the entire latex emulsion system. For instance, the present dispersion polymers are employed at levels from about 0.5% to about 8%, from about 0.5% to about 7%, from about 0.5% to about 6%, or from about 0.5% to about 5% by weight, based on the weight of the entire latex emulsion system.

The amount of the present liquid dispersion polymers and associative liquid dispersion polymers as thickeners may vary considerably depending upon variables including molecular weight and the choice of homopolymer or copolymer.

The present liquid dispersion polymers and associative liquid dispersion polymers are employed as thickeners in latex emulsion paints. Such formulations are well known and are described for example in U.S. Pat. Nos. 4,395,524, 2,795,564 and 3,356,627, the relevant disclosures of which are hereby incorporated by reference.

Accordingly, it is also subject of this application to provide a method for thickening or for providing viscosity control to aqueous latex emulsion coating compositions by adding thereto an effective amount of a present liquid dispersion polymer.

It is also subject of this invention to provide a method for thickening or for providing viscosity control to aqueous emulsion systems by adding thereto an effective amount of a present associative liquid dispersion polymer.

The present methods allow for the addition of essentially no cellulosic thickeners. For example, no cellulosic thickeners are added.

### EXAMPLES

The following liquid dispersion polymers (LDP) and associative liquid dispersion polymers (ALDP) are prepared by reverse phase emulsion polymerization. Percents are weight percent of entire compositon.
LDP1:
   40% copolymer of a 2:1:1 weight ratio of sodium acrylate: acrylic acid: acrylamide
   30% mineral oil
   10% ethoxylated tridecylalcohol
   20% mixture of water, residual volatile organics, polymeric stabilizer, sorbitan monoleate
LDP2:
   55% copolymer of 3:1 weight ratio of sodium acrylate: acrylic acid
   25% mineral oil
   5% ethoxylated tridecylalcohl
   15% mixture of water, residual volatile organics, polymeric stabilizer, sorbitan monoleate
LDP3:
   50% copolymer of 3:1 weight ratio of ammonium acrylate: acrylic acid
   25% mineral oil
   5% ethoxylated tridecylalcohol
   20% mixture of water, residual volatile organics, polymeric stabilizer, sorbitan monoleate
LDP4:
   45% copolymer of a 4:1:1 weight ratio of ammonium acrylate: acrylic acid: methacrylamide
   30% mineral oil
   10% ethoxylated tridecylalcohol
   15% mixture of water, residual volatile organics, polymeric stabilizer, sorbitan monoleate
LDP5:
   55% copolymer of a 3:1:1 weight ratio of ammonium acrylate: acrylic acid: acrylamide
   25% mineral oil
   5% ethoxylated tridecylalcohol
   15% mixture of water, residual volatile organics, polymeric stabilizer, sorbitan monoleate
ALDP1:
   40% copolymer of a 2:1:1 weight ratio of sodium acrylate: acrylic acid: acrylamide; including 1% by weight of stearyl ethoxy (10) allyl ether based on copolymer
   30% mineral oil
   10% ethoxylated tridecylalcohol
   20% mixture of water, residual volatile organics, polymeric stabilizer, sorbitan monoleate
ALDP2:
   55% copolymer of 3:1 mix of sodium acrylate: acrylicacid; including 0.5 weight percent behenyl ethoxy (25) methacrylate based on copolymer
   25% mineral oil
   5% ethoxylated tridecylalcohol
   15% mixture of water, residual volatile organics, polymeric stabilizer, sorbitan monoleate
ALDP3:
   50% copolymer of 3:1 mix of ammonium acrylate: acrylic acid; including 1% by weight stearyl ethoxy (20 methacrylate) based on copolymer
   25% mineral oil
   5% ethoxylated tridecylalcohol
   20% mixture of water, residual volatile organics, polymeric stabilizer, sorbitan monoleate
ALDP4:
   45% copolymer of a 4:1:1 weight ratio of ammonium acrylate: acrylic acid: methacrylamide; including 0.5% by weight stearyl ethoxy (10) allyl ether based on copolymer
   30% mineral oil
   10% ethoxylated tridecylalcohol
   15% mixture of water, residual volatile organics, polymeric stabilizer, sorbitan monoleate
ALDP5:
   55% copolymer of a 3:1:1 weight ratio of ammonium acrylate: acrylic acid: acrylamide; including 1% by
   weight stearyl ethoxy (20 methacrylate) based on copolymer
   25% mineral oil
   5% ethoxylated tridecylalcohol
   15% mixture of water, residual volatile organics, polymeric stabilizer, sorbitan monoleate

### Example 1

The following standard latex emulsion paint is prepared:

| | lbs per 100 gal |
|---|---|
| Grind | |
| dispersant | 11 |
| defoamer | 2 |
| propylene glycol | 60 |
| titanium dioxide | 270 |
| Letdown | |
| propylene glycol | 58 |
| acrylic polymer | 556 |
| | (46.5% solids) |
| preservative | 1 |
| coalescent | 16 |
| surfacant | 2 |
| water | 15 |
| defoamer | 3 |
| cellulose thickener/water | 80 |

The formulation is repeated, replacing the cellulose thickener with the present liquid dispersion polymers and associative liquid dispersion polymers above, LDP1-LDP5 and ALDP1-ALDP5. Excellent results are achieved. The inventive formulations exhibit excellent rheological properties, superior flow and leveling, good film build, good long term stability and excellent scrub resistance.

### Example 2

The following standard latex emulsion paint is prepared, 80% pigment volume concentration:

| | parts by | |
|---|---|---|
| | weight | |
| Grind: | | |
| titanium dioxide | 7.0 | |
| calcium carbonate | 41.0 | |
| water | 41.1 | |
| acrylic dispersant | 0.4 | |
| antifoam additive | 0.1 | |
| Let down: | | |
| vinyl acrylic latex | 9.4 | |
| coalescing solvent | 0.5 | |
| amine | 0.5 | |
| | 100 | parts |

Various thickeners are added to the let down. Levels of thickeners are shown in the table below, weight percent based on paint formulation. Viscosity is adjusted so as to be appropriate for a latex paint. Scrub resistance of coatings is measured on a Sheen Wet Abrasion Scrub Tester REF 903. Coatings on black Leneta scrub test panels/P121-10N (20 mils wet). Panels examined visually for paint film deterioration after coatings are dried for 24 hours, 48 hours and 1 week. Initial is first sign of failure. Final is complete failure.

| | | 24 hours | | 1 week | |
|---|---|---|---|---|---|
| Thickener | wt % wet/wet | initial | final | initial | final |
| ASE 1 | 2.3% | 50 | 100 | 125 | 270 |
| ASE 2 | 2.5 | 45 | 80 | 115 | 240 |
| HASE 1 | 1.0 | 160 | 375 | 360 | 1480 |
| HASE 2 | 1.2 | 200 | 410 | 330 | 1040 |
| HASE 3 | 1.0 | 180 | 360 | 400 | 1450 |
| HASE 4 | 0.8 | 185 | 375 | 540 | 1100 |
| HASE 5 | 1.3 | 180 | 350 | 700 | 1750 |
| HASE 6 | 1.8 | 110 | 220 | 520 | 1050 |
| LDP5 | 0.8 | >500 | — | >2000 | — |

ASE is alkali soluble emulsion. HASE is hydrophobically modified ASE. Each different commercially available samples.

Latex paint comprising as thickener a present liquid dispersion polymer exhibits excellent scrub resistance.

The scrub resistance experiments are repeated comparing a present liquid dispersion polymer thickener to different commercial samples of hydroxyethyl cellulose (HEC) and an associative HEC thickener. Results are in the table below.

| | | 48 hours | | 1 week | |
|---|---|---|---|---|---|
| Thickener | wt % dry/wet | initial | final | initial | final |
| HEC 1 | 1.0% | 900 | 1700 | 800 | 1950 |
| HEC 2 | 0.6 | 700 | 1500 | 700 | 2700 |
| associative HEC | 0.6 | 1800 | 3200 | 1900 | 3800 |
| LDP5 | 0.5 | >4000 | — | >4000 | — |

The present liquid dispersion polymer thickeners provide for excellent scrub resistance when substituted for HEC thickeners.

The scrub resistance experiments are repeated comparing a present liquid dispersion polymer thickener to an HEC thickener, where the latex is varied. Results are in the table below.

| | | wt % | 48 hours | | 1 week | |
|---|---|---|---|---|---|---|
| Thickener | latex | dry/wet | initial | final | initial | final |
| HEC 1 | vinyl acrylic | 1.1% | 10 | 50 | 30 | 90 |
| HEC 1 | styrene acrylic | 1.1 | 5 | 20 | 20 | 45 |
| HEC 1 | all acrylic | 1.1 | 20 | 50 | 120 | 2700 |
| HEC 1 | styrene butadiene | 1.1 | 5 | 20 | 5 | 20 |
| LDP5 | vinyl acrylic | 0.5 | 700 | 1200 | 750 | 2400 |
| LDP5 | styrene acrylic | 0.5 | 300 | 800 | 400 | 2700 |
| LDP5 | all acrylic | 0.5 | >4000 | — | >4000 | — |
| LDP5 | styrene butadiene | 0.5 | >4000 | — | >4000 | — |

The present liquid dispersion polymer thickeners provide for excellent scrub resistance when substituted for HEC thickeners, regardless of the nature of the latex.

1. An aqueous latex emulsion coating composition comprising a liquid dispersion polymer,
said liquid dispersion polymer comprising a hydrophilic nonionic or anionic homopolymer or copolymer dispersed in a hydrophobic liquid carrier and containing an oil-in-water activator surfactant and wherein the liquid dispersion polymer is in the form of microparticles.

2. A coating composition according to claim 1 which comprises essentially no cellulosic thickeners.

3. A coating composition according to claim 1 which comprises no cellulosic thickeners.

4. A coating composition according to claim 1 wherein the hydrophilic homopolymer or copolymer is derived from ethylenically unsaturated monomers selected from the group consisting of acrylic acid, methacrylic acid, alkali metal or ammonium salts of acrylic acid or methacrylic acid, 2-acrylamido-2-methyl-propanesulfonic acid or its alkali metal or ammonium salts, sodium styrene sulfonate, acrylamide, methacrylamide, N-vinyl pyrrolidone and water soluble hydroxy-substituted acrylic or methacrylic esters.

5. A coating composition according to claim 1 wherein the hydrophilic homopolymer or copolymer is derived from ethylenically unsaturated monomers selected from the group consisting of acrylic acid, acrylic acid sodium salt, acrylic acid ammonium salt, methacrylic acid, methacrylic acid sodium salt, methacrylic acid ammonium salt, acrylamide and methacrylamide.

6. A coating composition according to claim 1 wherein the liquid dispersion polymer comprises
from about 35% to about 65% by weight of the hydrophilic nonionic or anionic homopolymer or copolymer,
from about 10% to about 50% by weight of a hydrophobic liquid carrier,
and from about 5% to about 25% by weight of a surfactant mixture of a low HLB water-in-oil surfactant and a high HLB oil-in-water activator surfactant,
each based on the weight of the total composition.

7. A coating composition according to claim 1 wherein the liquid dispersion polymer comprises
from about 45% to about 58% by weigb of the nonionic or anionic homopolymer or copolymer,
from about 20% to about 40% by weight of a hydrophobic liquid carrier, and
from about 10% to about 18% by weight of a surfactant mixture of a low HLB water-in-oil surfactant and a high HLB oil-in-water activator surfactant,
each based on the weight of the total composition.

8. A coating composition according to claim 1 wherein the liquid dispersion polymer comprises
from about 45% to about 58% by weight of an anionic copolymer comprising monomer units derived from acrylic acid and an alkali metal or ammonium salt of acrylic acid, and
from about 22% to about 38% by weight of a hydrophobic liquid carrier, and
from about 12% to about 18% by weight of a surfactant mixture of a low HLB water-in-oil surfactant and a high HLB oil-in-water activator surfactant,
each based on the weight of the total composition.

9. A coating composition according to claim 1 wherein the liquid dispersion polymer comprises an anionic acrylic acid copolymer comprising monomer units derived from acrylic acid and an alkali metal or ammonium salt of acrylic acid, and wherein greater than about 50% of the acid groups in the anionic acrylic acid copolymer are in the form of a salt.

10. A coating composition according to claim 1 wherein the liquid dispersion polymer comprises an anionic acrylic acid copolymer comprising monomer units derived from acrylic acid and a sodium or ammonium salt of acrylic acid, and wherein from about 65% to about 85% of the acid groups in the anionic acrylic acid copolymer are in the form of their sodium or ammonium salt.

11. A coating composition according to claim 1 wherein the oil-in-water surfactant is an ethoxylated aliphatic alcohol.

12. A coating composition according to claim 1 wherein said liquid dispersion polymer is present from about 0.5% to about 8% by weight, based on the weight of the entire composition.

13. An associative liquid dispersion polymer, said liquid dispersion polymer comprising a hydrophilic nonionic or anionic copolymer dispersed in a hydrophobic liquid carrier and containing an oil-in-water activator surfactant and wherein the liquid dispersion polymer is in the form of microparticles, and
wherein the copolymer contains a minor amount of associative monomer units derived from ethylenically unsaturated monomers selected from the group consisting of the associative monomers.

14. An associative polymer according to claim 13, wherein the associative monomers are selected from the group consisting of stearyl ethoxy (20) methacrylate, behenyl ethoxy (25) methacrylate, stearyl ethoxy (10) allyl ether, poly(ethylene glycol)(meth)acrylate, poly(ethylene glycol)monomethyl ether mono(meth)acrylate, poly(ethylene glycol)acrylate and poly(ethylene glycol)monomethyl ether monoacrylate.

15. An associative polymer according to claim 13, wherein the associative monomers are selected from the group consisting of stearyl ethoxy (20) methacrylate, behenyl ethoxy (25) methacrylate and stearyl ethoxy (10) allyl ether.

16. An associative polymer according to claim 13, wherein the associative monomer units are present in the copolymer at less than about 5% by weight, based on the weight of the copolymer.

17. An associative polymer according to claim 13, wherein the associative monomer units are present in the copolymer at less than about 2% by weight, based on the weight of the copolymer.

18. An associative polymer according to claim 13 wherein a major portion of the hydrophilic copolymer is derived from ethylenically unsaturated monomers selected from the group consisting of acrylic acid, methacrylic acid, alkali metal or ammonium salts of acrylic acid or methacrylic acid, 2-acrylamido-2-methyl-propanesulfonic acid or its alkali metal or ammonium salts, sodium styrene sulfonate, acrylamide, methacrylamide, N-vinyl pyrrolidone and water soluble hydroxy-substituted acrylic or methacrylic esters.

19. An associative polymer according to claim 13 wherein a major portion of the hydrophilic homopolymer or copolymer is derived from ethylenically unsaturated monomers selected from the group consisting of acrylic acid, acrylic acid sodium salt, acrylic acid ammonium salt, methacrylic acid, methacrylic acid sodium salt, methacrylic acid ammonium salt, acrylamide and methacrylamide.

20. An associative polymer according to claim 13 which comprises
from about 35% to about 65% by weight of the hydrophilic nonionic or anionic copolymer,
from about 10% to about 50% by weight of a hydrophobic liquid carrier,
and from about 5% to about 25% by weight of a surfactant mixture of a low HLB water-in-oil surfactant and a high HLB oil-in-water activator surfactant,
each based on the weight of the total composition.

21. An associative polymer according to claim 13 which comprises
from about 45% to about 58% by weight of the nonionic or anionic copolymer,
from about 20% to about 40% by weight of a hydrophobic liquid carrier, and
from about 10% to about 18% by weight of a surfactant mixture of a low HLB water-in-oil surfactant and a high HLB oil-in-water activator surfactant,
each based on the weight of the total composition.

22. An associative polymer according to claim 13 which comprises
from about 45% to about 58% by weight of an anionic copolymer comprising a major portion of monomer units derived from acrylic acid and an alkali metal or ammonium salt of acrylic acid, and
from about 22% to about 38% by weight of a hydrophobic liquid carrier, and
from about 12% to about 18% by weight of a surfactant mixture of a low HLB water-in-oil surfactant and a high HLB oil-in-water activator surfactant,
each based on the weight of the total composition.

23. An associative polymer according to claim 13 which comprises an anionic acrylic acid copolymer comprising a major portion of monomer units derived from acrylic acid and an alkali metal or ammonium salt of acrylic acid, and wherein greater than about 50% of the acid groups in the anionic acrylic acid copolymer are in the form of a salt.

24. An associative polymer according to claim 13 which comprises an anionic acrylic acid copolymer comprising a major portion of monomer units derived from acrylic acid and a sodium or ammonium salt of acrylic acid, and wherein from about 65% to about 85% of the acid groups in the anionic acrylic acid copolymer are in the form of their sodium or ammonium salt.

25. An associative polymer according to claim 13 wherein the oil-in-water surfactant is an ethoxylated aliphatic alcohol.

26. An aqueous emulsion system comprising an associative liquid dispersion polymer,
said liquid dispersion polymer comprising a hydrophilic nonionic or anionic copolymer dispersed in a hydrophobic liquid carrier and containing an oil-in-water activator surfactant and wherein the liquid dispersion polymer is in the form of microparticles, and
wherein the copolymer contains a minor amount of associative monomer units derived from ethylenically unsaturated monomers selected from the group consisting of the associative monomers.

27. An aqueous emulsion system according to claim 26 that comprises essentially no cellulosic thickeners.

28. An aqueous emulsion system according to claim 26 that comprises no cellulosic thickeners.

29. An aqueous emulsion system according to claim 26 selected from the group consisting of coatings compositions, adhesives, inks, pigment dispersions and latex.

30. An aqueous emulsion system according to claim 26 wherein said liquid dispersion polymer is present from about 0.5% to about 8% by weight, based on the weight of the entire composition.
